(19) United States
(12) Patent Application Publication
(10) Pub. No.: US 2004/0083169 A1
(43) Pub. Date: Apr. 29, 2004

(54) Method and systems to identify and control payment fraud

(75) Inventors: Brian Dentler, Herman, NE (US); John Timothy Place, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/618,072

(22) Filed: Jul. 11, 2003

Related U.S. Application Data
(60) Provisional application No. 60/400,776, filed on Aug. 2, 2002.

(51) Int. Cl. G06F 17/60

(52) U.S. Cl. 705/40; 705/39

(57) ABSTRACT

Methods and systems are provided for processing payments towards a credit account that use historical record information to limit the potential for payment fraud. A history of profile records that extends over a period of time that preceding receipt of a payment is analyzed to determine whether to float the payment. Each of the profile records includes information about the status of the credit account at a particular date within the period of time, such as an account balance for that date and a value for all credited payments made towards the credit account on that date.

### CROSS REFERENCE TO RELATED APPLICATION

This application is a nonprovisional of, and claims the benefit of the filing date of, U.S. Prov. Pat. Appl. No. 60/400,776, entitled “METHODS AND SYSTEMS TO IDENTIFY AND CONTROL PAYMENT FRAUD,” filed Aug. 2, 2002 by Brian Dentler and Tim Place, the entire disclosure of which is incorporated herein by reference for all purposes.

### BACKGROUND OF THE INVENTION

This application relates generally to the management of credit accounts. More specifically, this application relates to methods and systems to identify and control payment fraud in credit accounts.

One piece of account information maintained by a credit provider for each of its accounts is the outstanding balance. This balance may fluctuate regularly as a customer obtains credit advances against the account and makes payments towards the account. In managing the account, this information may be supplemented with demographic information about the customer. Such information is used by the credit provider in managing the account, referring to the existing account balance and demographic information in making administrative decisions about the account. Such administrative decisions may include, for example, whether to honor a request by the customer for an increase in credit limit or to waive an annual service charge.

Another decision made by the credit provider when it receives a customer payment is whether to float the payment or put the payment on hold until it clears. Usually, customer payments are made by check and the credit provider is exposed to a risk that the check will be dishonored. This risk may be mitigated by refusing to credit the credit account with the amount of the check until the check has cleared. Doing so, however, can be detrimental to customer relations since the majority of customers present valid checks and expect their accounts to be credited upon receipt of the checks by the credit provider. In some instances, the credit provider may even lose business directly while the customer is prevented from obtaining further credit advances until the check has cleared; this is most likely to occur where the customer's outstanding balance is close to his credit limit.

The risk of payment fraud further inhibits the credit provider from posting the payment until the check has cleared. If the credit provider posts the amount of a check to a credit account before it clears, it is exposed to a scheme in which the customer sends multiple bad checks in succession over a short period of time. The posting of the original payment amount increases the credit available to the customer until an attempt is made to correct the posting when the check is dishonored. During that time, however, the increased available credit may be used fraudulently.

The fraud scheme is sometimes applied to a credit account that is delinquent. Receipt of an initial bad check, even if floated by the credit provider in response to the delinquent status of the account, may nevertheless remove the delinquency from the account. This may then be exploited so that subsequent bad checks are used as described above to use an increased level of available credit fraudulently.

There is a general need in the art for methods and systems that will enable a credit provider to process customer payments to limit the potential impact of payment fraud.

### BRIEF SUMMARY OF THE INVENTION

Embodiments of the invention thus provide a method for processing a payment towards a credit account that uses historical record information to limit the potential for payment fraud. In one such embodiment, a history of profile records is used for the credit account. This history extends over a period of time that precedes receipt of the payment and each of the profile records includes information about the status of the credit account at a particular date within the period of time. For example, the profile record may include an account balance for that date and a value for all credited payments made towards the credit account on that date. The payment is processed by retrieving this history and performing an analysis of the history to determine whether to float the payment.

The information included as part of the profile records may differ in different embodiments. For example, in one embodiment, each profile record includes an indication of whether any prior payments made towards the credit account are floating as of the date of the profile record. In another embodiment, the number of credited payments made towards the credit account within a time window preceding the date are included. This time window may have a different length than the length of the retrieved profile-record history, but both of these lengths will usually be at least as great as an expected time for a payment to be cleared. In a further embodiment, each of the profile records includes a cumulative value of credited payments made towards the credit account within a time window. In still another embodiment, each profile record includes a behavior score.

The analysis of the profile records may also proceed differently in different embodiments. In one embodiment, a worst-case profile is developed from the history of profile records. This worst-case profile may simply be the worst profile in the history, but may alternatively be a composite constructed from multiple profiles in the history. Such a composite will generally include the worst of different specific elements of the profiles selected from across all the profiles in the history. If the analysis results in a decision to float a payment, it is possible that the entire payment may be floated or that only a portion of the payment be floated. Further, if at least a portion of a payment is to be held, the time to hold that portion of the payment is determined.

The methods of the present invention may be embodied in a computer-readable storage medium having a computer-readable program embodied therein for directing operation of a computer system. Such a computer system may include a processor and a storage device. The computer-readable program includes instructions for operating the computer system to process payments towards a credit account in accordance with the embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 is a flow diagram illustrating an embodiment of the invention;

FIGS. 2A-2L are schematic diagrams illustrating a data architecture used with embodiments of the invention; and

FIG. 3 is a schematic illustration of a computer system that may be configured to implement methods of the invention.

### DETAILED DESCRIPTION OF THE INVENTION

Embodiments of the invention provide methods and systems for processing payments towards a credit account that mitigate the potential for payment fraud. The credit account is used as part of a credit arrangement between a customer and a credit provider. The credit account comprises a balance owed by the customer to the credit provider that may vary as a result of credit charges made by the customer, payments made by the customer, interest levied by the credit provider, service charges applied by the credit provider, and perhaps other adjustments. Usually the balance will be positive, indicating that money is owed by the customer to the credit provider, although the balance may be negative to indicate that money is owed by the credit provider to the customer. In many instances, the credit account will also comprise a credit limit so that credit charges by the customer will usually be declined if they would cause the balance to exceed the credit limit. In some cases, the credit limit may nevertheless be exceeded, such as through discretionary approval of credit charges that cause this result or by the accumulation of interest and/or service charges, particularly for a delinquent credit account. In some instances, the credit account may be associated with a card used to make purchases at merchants, but this is not required; for example, the credit account may be associated with such financial products as a line of credit provided by a financial institution or even an overdraft-protection arrangement for a checking account.

The credit account is typically managed by the credit provider according to a cycle that determines when a statement may be sent to the customer and a cutoff when charges made against the credit account will be included in a forth coming statement. As will become evident from the following discussion, embodiments of the invention effectively avoid data artifacts that might otherwise result from administration according to the cycle. The methods of the invention are not wedded to information defined by positions within the cycle, such as account status at the beginning or end of the cycle.

According to embodiments of the invention, a decision is made whether to float at least a portion of each non-cash-equivalent payment made by a customer towards his credit account. The decision is based on an analysis of a history of profile records for the credit account over a period of time preceding the payment. Each of the profile records corresponds to a snapshot of the status of the credit account at different specific times within the period of time examined. Because this history is continually updated as a result of activity with respect to the credit account, the history of profile records is sometimes referred to herein as a “pipeline.” In one embodiment, the analysis of the pipeline seeks to develop a worst-case profile from which the decision whether to float is made. By preserving this historical information about the credit account, attempts to subvert the records of the credit provider with a payment-fraud scheme are avoided. In one embodiment, the pipeline has a length at least as great as the statement cycle.

The effectiveness of the analysis may depend in part on the content of each of the profile records in the pipeline. In one embodiment, each of the profile records corresponds to a date within the period of time covered by the pipeline and includes (1) an account balance for the credit account on that date and (2) a value of credited payments made towards the credit account on that date. In other embodiments, still further data relevant to any algorithm used by the analysis may also be included as part of each profile record. For example, the data comprised by the profile records may itself have a historical component by including such information as the number of credited payments, or total value of those payments, made towards the credit account within a time window preceding the date of the profile record.

This additional historical component may manifest itself in the analysis in the following way. Consider, for example, the analysis in which a worst-case profile is developed from profile records in the pipeline. If, at some time in the pipeline, a characteristic of the credit account was that a large number of payments had been made in a short period of time, this characteristic may form part of the worst-case profile and be used as factor in deciding whether to float a current payment. Maintaining this information as part of the individual profiles is a convenient mechanism to include second-order information about account history as a relevant model factor in the analysis.

The profile records may also include a behavior score. Such a score is derived from a model that correlates factors statistically relevant to whether a customer will repay credit extended through the credit account. Generally, the behavior score increases in response to favorable behavior by the customer, such as paying requested amounts when due, and decreases in response to unfavorable behavior, such as allowing the account to become delinquent or by presenting a payment this is subsequently dishonored. The behavior score may also be affected by more static demographic factors.

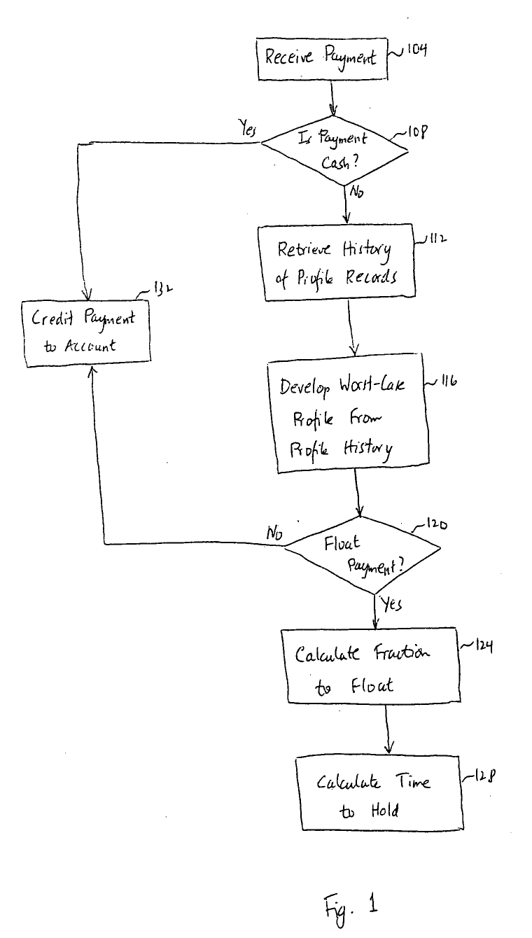

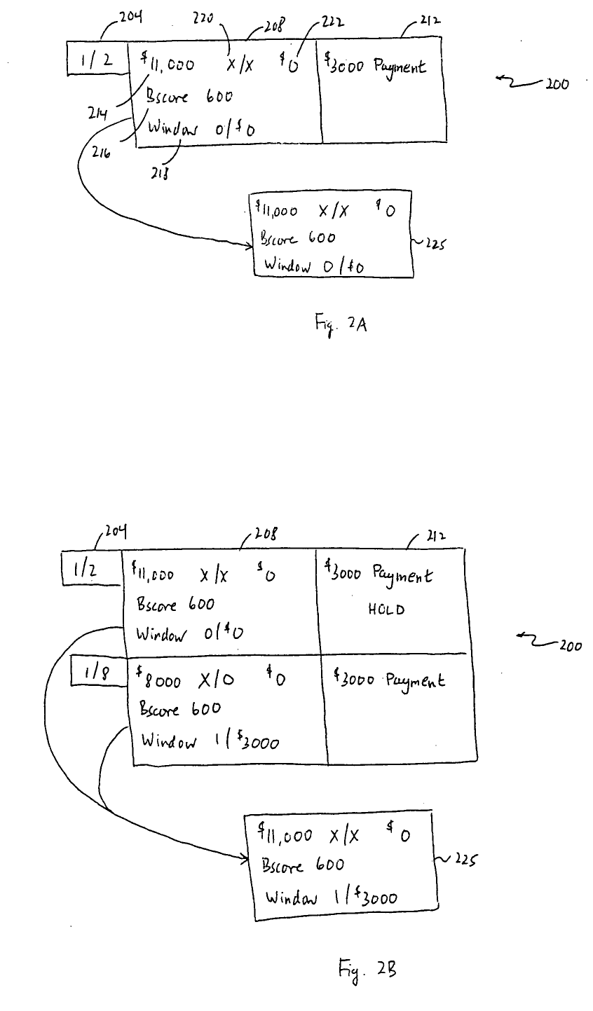

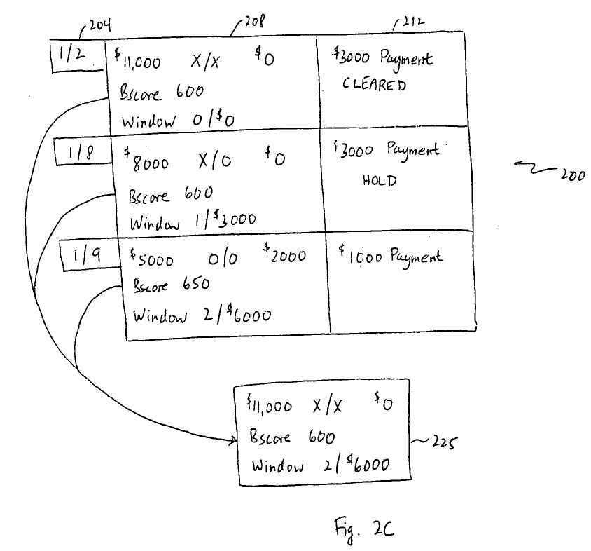

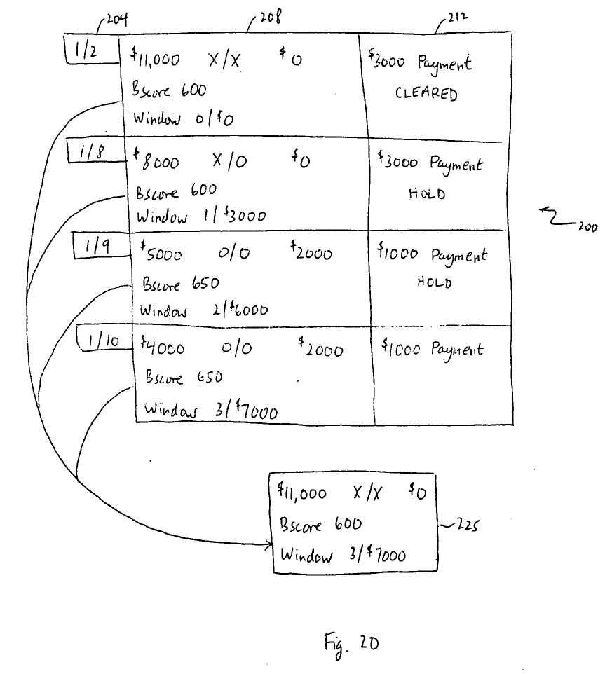

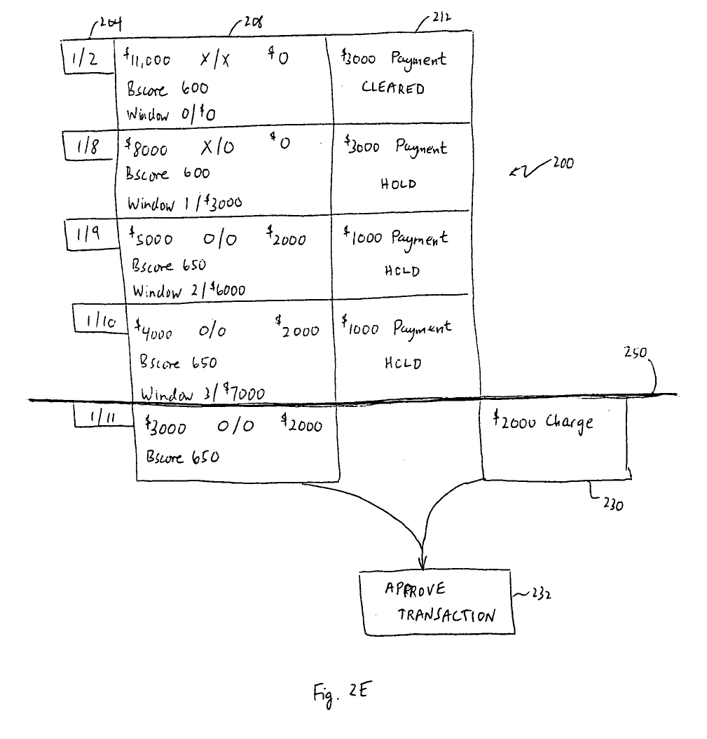

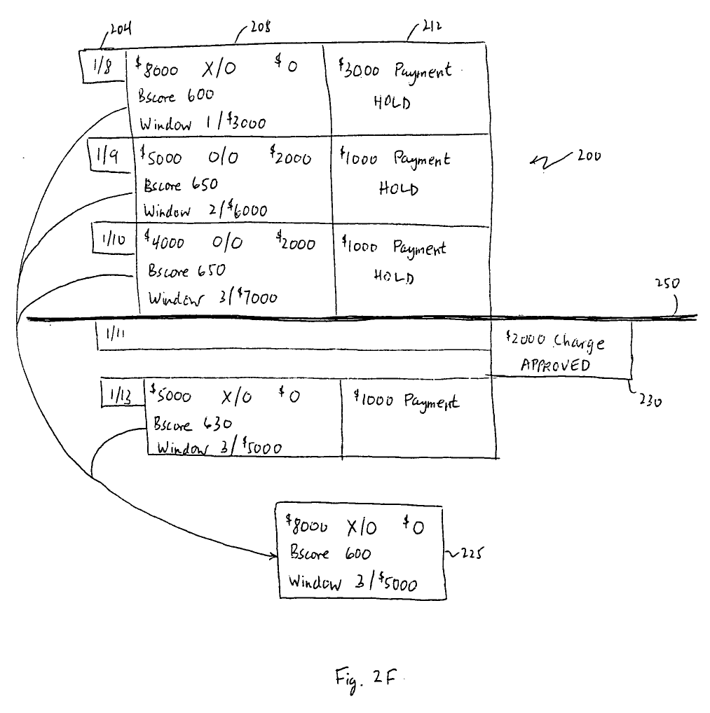

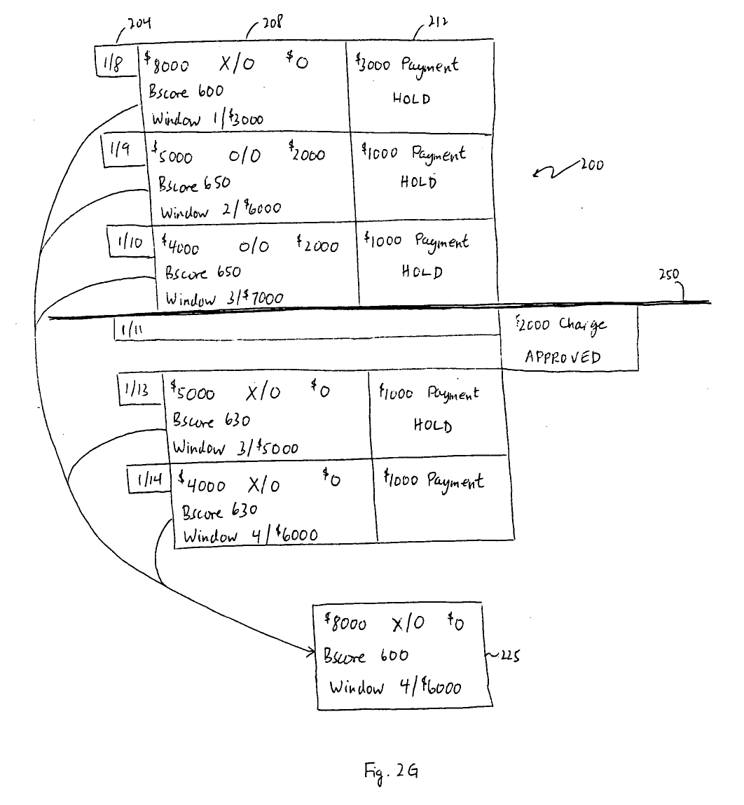

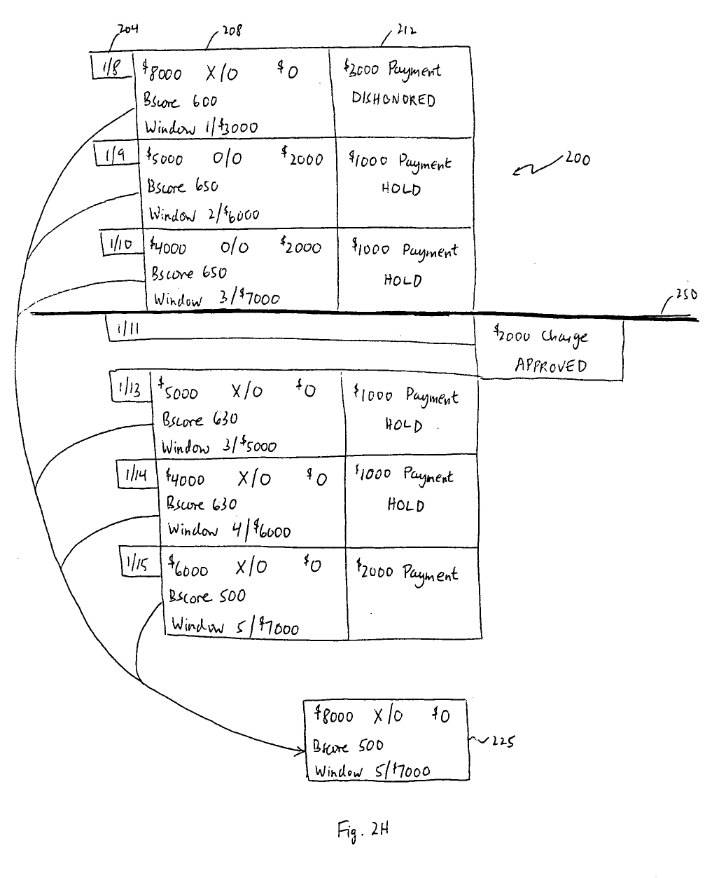

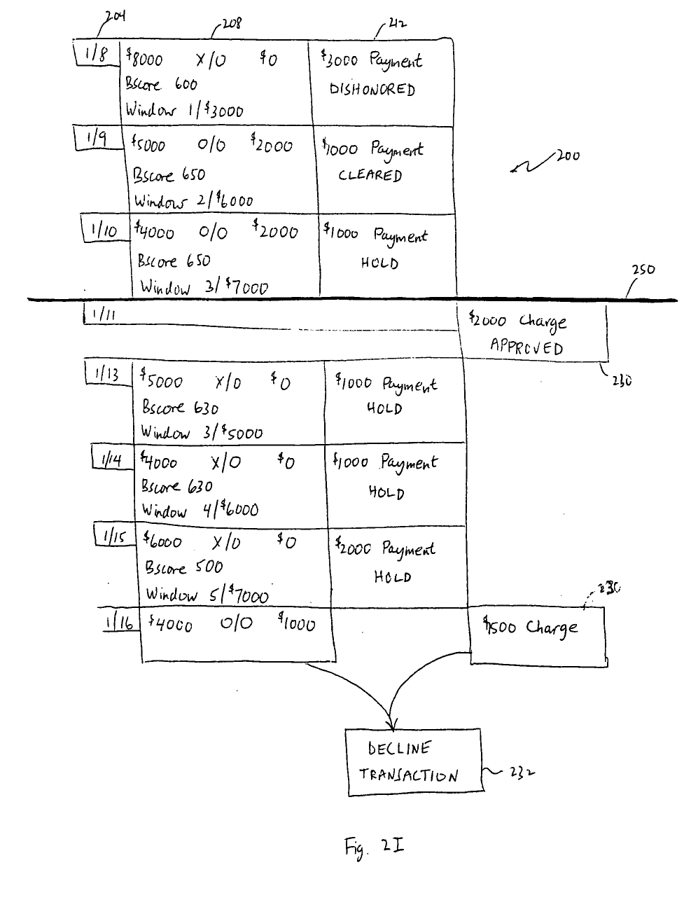

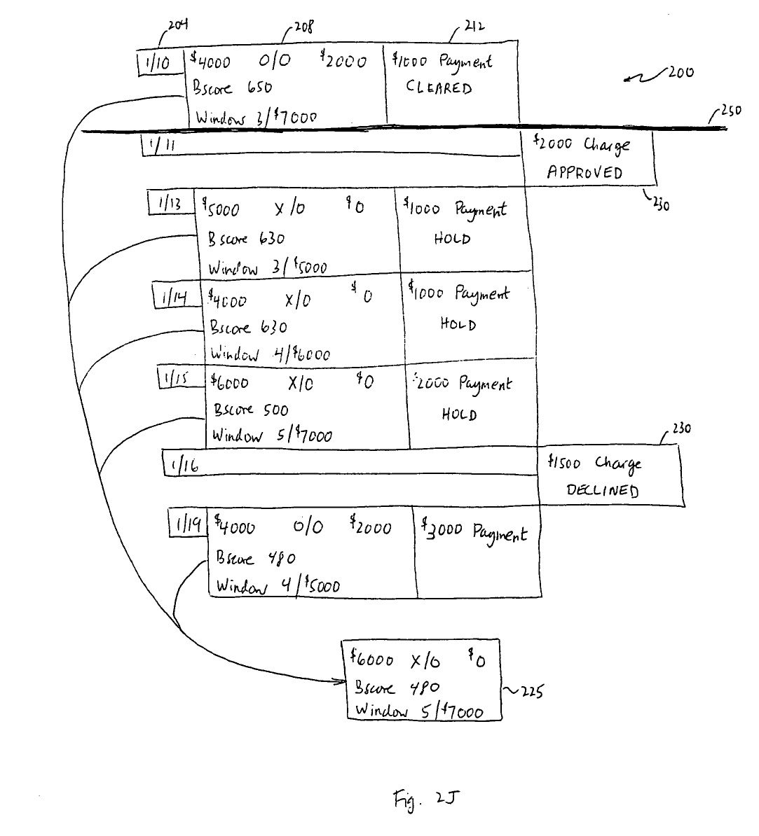

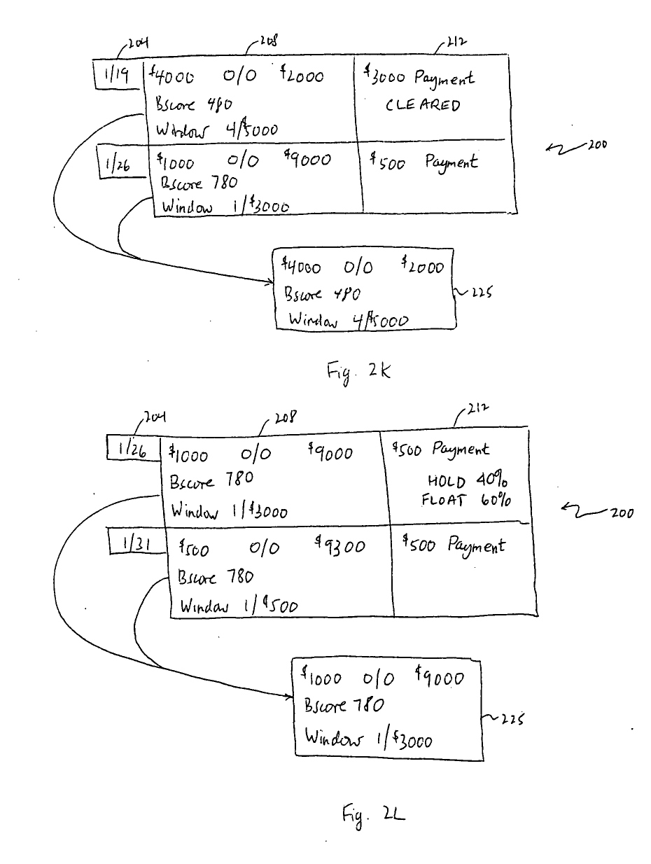

An embodiment is illustrated specifically in FIGS. 1 and 2A-2L. FIG. 1 provides a flow diagram for the general method and FIGS. 2A-2L provide examples of profile records included in the pipeline for a specific case as they evolve in response to payments and credit charges, and are used in determining whether to float or to hold payments.

Referring to the overview of the embodiment in FIG. 1, at block 104 a payment is received by the credit provider. If the payment is a cash or cash-equivalent payment, as determined at block 108, the payment is simply credited to the credit account at block 132. If it is determined at block 108 that the payment is not cash or its equivalent, the pipeline of profile records is retrieved at block 112. In the illustrated embodiment, the worst-case profile is developed from the profile records in the pipeline at block 116. This worst-case profile is used at block 120 to determine whether to float or to hold any portion of the payment. In alternative embodiments, the analysis of blocks 116 and 120 may be substituted with an alternative method of analyzing the profile records from the pipeline without specific development of a worst-case profile.

If the analysis of the worst-case profile indicates that it is unlikely that the payment will be dishonored, the payment is floated so that the credit account is credited in full at block 132. If there is a sufficient risk of dishonor, however, at least a portion of the payment will be held so that the level of credit available to the customer will not be fully increased in immediate response to the payment. Instead, the account balance will be only provisionally reduced, with the level of available credit being increased a corresponding amount only when the hold time has expired. At blocks 124 and 128, the fraction of the payment to float and the hold time are respectively calculated. As suggested, it is possible in some instances to float only a portion of the payment so that while the account balance is provisionally reduced, some portion of the payment is applied to increase the level of available credit; the remaining increase in level of available credit occurs after the hold time has passed. The hold time itself will generally be related to the expected time for a specific payment to clear. Such factors in determining hold time are thus usually related more to the type of payment that is made than to the account characteristics determined from the pipeline analysis.

In the example used for illustrative purposes in FIGS. 2A-2L, a credit account having a limit of $10,000 is considered. The figures sequentially show the evolution of the pipeline 200 as payments and charges are made for the credit account over time. The pipeline 200 is illustrated in this embodiment as including profile records only on those dates where an action is taken. This is well suited for an analysis scheme that develops a worstcase profile from the pipeline. In other embodiments, the pipeline 200 may include profile records for other dates as well.

An example of a profile record having a date field 204, a profile field 208, and a payment field 212 is provided in FIG. 2A as the only profile record in the pipeline 200. The date field 204 specifies the date that corresponds to both the profile field 208 and the payment field 212. Within the payment field 212, a record is provided of any payments towards the credit account received on the date specified in the date field, as well as an indication of their status. In FIG. 2A, no status is indicated for the $3000 payment received since no decision has yet been made how to treat the payment.

Within the profile field 208, a number of different parameters may be maintained. No particular format for the parameters within the profile field 208 is required. In the illustration, the profile field provides the following information for the credit account on the specific date reflected in the date field 204: (1) a balance record 214; (2) a status record 220; (3) an available-credit record 222; (4) a behavior-score record 216; and (5) a window record 218 specifying the number and total value of payments received during a preceding time window.

The balance record 214 specifies the balance on the credit account. The status record 220 specifies the external and internal status of the credit account. In the illustration, each of the external and internal status can take only two values. The external status can be either “prohibited” (denoted “X”) or “allowed” (denoted “O”) to indicate externally whether charges against the account are permitted. The internal status can be either “delinquent” (denoted “X”) or “clear” (denoted “O”) to indicate internally whether the account is in a delinquent state. In other embodiments, more and/or different states may be specified for the status record 220 both externally and internally. The available-credit record 222 specifies the level of credit available to the customer on the credit account; the difference between it and the balance may not be equal to the credit limit if the balance exceeds the credit limit or if payments are currently being held. The behavior-score record 216 specifies the behavior score. The window record 218 specifies the number and total value of payments received during a preceding time window.

In the illustration, the time window used for the window record 218 is ten days, as is the period of time that defines the pipeline. The time for a check to clear is presumed to be five to seven days so that the hold time for any decision to hold a payment or payment portion is taken to be seven days. On the January 2 date of FIG. 2A, the account balance is $11,000 and therefore exceeds the credit limit. For purposes of illustration, this is presumed to have arisen from a long period without payment being received from the customer. Accordingly, the status record 220 indicates both that the credit account is delinquent and that further charges against it are prohibited, and the available credit is shown to be zero. The behavior score is 600 and the window record 218 indicates that no payments have been received in the last ten days.

The decision of whether to float the $3000 payment received on January 2 is straightforward. Since only one profile record is included in the pipeline 200, it alone is used to generate the worst-case profile 225. There are sufficient negative indications in the worstcase profile 225 for a decision to be made to hold the payment by not raising the level of available credit above zero for the seven-day hold period. These negative indications include the fact that the account is delinquent and the fact that the balance in the worst-case profile 225 exceeds the credit limit.

The payment field 212 of the profile record for January is thus updated to reflect that the $3000 payment made on that day is held, as shown in FIG. 2B. Also shown in FIG. 2B is the pipeline 200 on January 8 when another $3000 payment is received. At this time, the profile field 208 on January 8 shows a change from the profile field 208 of January 2 to reflect the fact that a payment has been received—(1) the balance is now provisionally shown to be $8000; the internal delinquency status of the credit account has been removed, i.e. the status record now shows “X/O” instead of “X/X”; and (3) the window record indicates that within the last ten days a total of one payment has been received having a total value of $3000. The behavior score calculated by the behavior model is, in this instance, unchanged. The pipeline 200 now includes profile records from at least both January 2 and January 8, and in some embodiments may also include profile records for all intermediate dates, although the profile will usually be the same on those intermediate dates since there has been no account activity until January 8.

The method proceeds with the pipeline 200 shown in FIG. 2B in the same fashion. After determining that the new $3000 payment is not a cash payment or its equivalent, a worst-case profile 225 is developed. The worst-case profile 225 may be considered to a compilation of the worst aspects of the profile records in the pipeline 200. In this instance, it shows: (1) a balance of $11,000, which exceeds the credit limit; (2) negative external and internal statuses so that further charges are prohibited on a delinquent account; (3) no available credit; (4) a behavior score of 600; and (5) a window history in which one payment has been made in the last ten days for a total value of $3000. The first three of these pieces of data are from the January 2 profile record, the last is from the January 8 profile record, and the behavior score may be from either. There is sufficient negative information in the worst-case profile record 225 that the new $3000 payment will also not be floated. In this embodiment, the $3000 payment made on January 2, even though records show it removed the delinquency from the account, is insufficient by itself for subsequent payments to result in an immediate increase in available credit.

This decision is reflected in the profile record for January 8 shown in FIG. 2C. In this instance, another payment of $1000 is made on January 9. Since seven days have now passed since the first $3000 payment was received, its status is updated in the payment field for January 2 to show that the payment cleared. The results of this, coupled with the $3000 payment on January 8 are reflected in the profile field 208 for January 9: (1) the balance is reduced to $5000; (2) the available credit has been increased to $2000, equal to the difference between the cleared $3000 January 2 payment and the $1000 by which the account limit had previously been exceeded; (3) the status record shows both the external and internal status to be clear so that charges are permitted and there is no internally recorded delinquency; (4) the behavior score has been increased to 650 in accordance with the behavior model; and (5) the window record reflects that within the past ten days two payments have been made for a total of $6000.

While the payments towards the account, particularly the payment that has cleared, have resulted in a considerable improvement in the profile as shown in the profile field 208 of January 9, the worst-case profile 225 shows little change. Since the worst-case profile 225 is developed from all profile records in the pipeline 200, it continues to show significant negative information that is used to decide whether to float or hold the $1000 January 9 payment. This decision is based on an account profile in which the balance exceeds the credit limit, external and internal statuses are negative, available credit is zero, the behavior score is 600, and two payments totaling $6000 have been made in the last ten days. The decision to hold the $1000 payment by not increasing the available credit reflects the fact that the risk of payment fraud is still sufficiently high despite the fact that the $3000 January 2 payment has cleared.

This decision is reflected in the payment field 212 of FIG. 2B, which indicates that the January 9 payment is also held. A further payment of $1000 on January 10 results in little change in the profile field 208 other than to show a provisional decrease in the balance and a history in the window record that three payments totaling $7000 have been made in the last ten days. Because the worst-case profile 225 in this instance also includes significant negative information, the $1000 January 10 payment is also held.

On January 11, the customer attempts to make a charge against the credit account, as shown in the charge field 230 in FIG. 2E. The pipeline 200 still includes the profile records for the last ten days, from January 2, and a decision 232 whether to approve the charge request is made by comparing the requested charge against the current January 11 profile field 208. The profile field 208 on this date indicates that external charges are permitted up to a limit of $2000. Notably, even though the provisional balance is only $3000 on an account with a limit of $10,000, no credit charges will be approved larger than $2000. This reflects the fact that some of the previous payments have not yet cleared and that there is still a risk with this account that those payments may be part of a payment-fraud scheme. Since the illustration shows only a request for a $2000 charge in the charge field 230, the transaction is approved at block 232.

FIG. 2E also shows that the statement cycle 250 was reached at the end of January 10. If the decision-making process relied on information as of the cycle date, it would not benefit from the historical information available in accordance with the invention. As will be further evident from the subsequent transactions described, the existence of a cycle date does not impede the decision-making analysis.

FIG. 2F shows the pipeline 200 as of January 13 when another $1000 payment is received. There are a number of features to note. First, since the pipeline extends for a period of ten days, the profile record for January 2 has been dropped. Second, the effect of the $2000 charge on January 11 is reflected in the profile field 208 for January 13: (1) the account balance has been increased by the $2000 charge to $5000; (2) the available credit has been decreased by $2000 to zero, with a corresponding change in the external status record to show that further charges against the account are now prohibited; and (3) the behavior score has been modified. In addition, although the illustration includes a total of four payments made before January 13, the window field indicates only that three payments have been made for a total of $5000. This is because the window field reflects the number and value of payments made for the previous ten-day period, and the $3000 January 2 payment is not included.

One effect of dropping the profile record for January 2 from the pipeline is that the developed worst-case profile 225 is improved over the worst-case profile for the earlier dates. Nevertheless, this worst-case profile 225 still indicates that sometime during the period of the pipeline the account balance was as high as $8000 and the external status record prohibited further charges from being made. Accordingly, the decision is to hold the $1000 payment and not to increase the available credit until that payment has cleared.

The result of this decision is shown in FIG. 2G where the profile record 208 for January 14 reflects both the provisional decrease in the balance and an increase in the number and value of payments made in the previous ten days in the window record. Since none of the previous payments have yet cleared, the worst-case profile 225 is approximately the same as it was on January 13, resulting in a further decision to hold the $1000 payment. It is noted that these decisions are all made without regard to position within the statement cycle 250, which now originates approximately in the middle of the pipeline 200.

On January 15, as shown in FIG. 2H, the benefit of using the decision analysis exemplified in this embodiment is demonstrated when the January 8 payment of $3000 is dishonored. The methods and systems of the invention have prevented exposure of the credit provider to a payment-fraud scheme that may have resulted from the dishonored payment. The profile field 208 on January 15 reflects the dishonor of the earlier payment, as well as the provisional recognition of the payment on January 14: (1) the provisional balance is increased from $4000 to $6000 to accommodate both the $1000 January 14 payment and a retraction of the provisional crediting of the January 8 payment. In addition, the behavior score is reduced to 500 to recognize that the customer presented a payment that was dishonored. Also, the window record reflects now that five payments have been made in the last ten days totaling $7000.

Also on January 15, a further payment of $2000 towards the credit account has been received. The worst-case profile record 225 now includes negative information both from January 8 when the balance was $8000 and from January 15 when the behavior score is low and there is an apparent effort on the part of the customer to make a large number of as-yet not cleared payments in a short time window. This negative information is used again to hold the new $2000 payment and refuse to increase the available credit from its current value of zero until that payment has cleared.

By January 16, as shown in FIG. 21, the $1000 payment received on January 9 has cleared. The information regarding the credit account so far is appropriately mixed since some of the payments have cleared while others have been dishonored. As a result of the clearing of the January 9 payment, the profile field 208 for January 16 is adjusted to reflect that $1000 is now available for credit and the external status field is cleared to indicate that charges may be accepted against the credit account. In addition, the balance in that profile field 208 has been adjusted to reflect the provisional crediting of the $2000 January 15 payment towards the balance.

Also on January 16, the customer attempts to make a charge for $1500 as shown in the charge field 230. A decision 232 whether to authorize the charge is made by comparing the requested amount of the charge with the level of available credit. In this instance, the request exceeds the $1000 of available credit, even though the balance is only $4000 for a credit account having a credit limit of $10,000. Accordingly, the transaction is denied at block 232.

One effect of attempting to execute a credit charge that needed to be declined is reflected in still a further reduction in behavior score in the profile field 208 shown in FIG. 2J for January 19. By this time, more than seven days have passed since the January 10 payment was made, which is shown as having cleared in the payment field 212 for January 10. As a result, the available credit shown in the profile field 208 for January 19 has been increased by $1000 to $2000 to reflect the cleared payment. FIG. 2J also shows that the pipeline 200 has dropped the profile records for January 8 and January 9 since they are now outside the time period used to define the pipeline 200.

By the time of January 19, most of the payments made by the customer have cleared despite the one payment that was dishonored, so the condition of the account reflected in the profile field on that date is relatively positive. When the customer tenders a further payment of $3000, however, it is the developed worst-profile record 225 that is used in deciding how to treat the payment. In this instance, the worst-profile record 225 continues to include the recent historical information that the account had a $6000 balance but was prohibited externally from further transaction approvals because the available credit was zero. Moreover, recent behavior scores were as low as 480 and the window element indicates that a relatively large number of shortly spaced payments have been made. Thus, despite the general trend towards improvement in the status of the credit account, a decision is made to float only a portion of the $3000 January 19 payment. In this illustration, because there is still significant negative information in the worst-profile record 225, only 20% of the payment is floated—$600 is floated by increasing the available credit to $2600 and the remaining $2400 of the payment is held until the payment clears.

In the illustration, the account continues to improve its status. By January 26, a full week later, all of the payments made by the customer have cleared except for the January 8 payment. The pipeline shown in FIG. 2K includes only two profile records that fall within the prescribed time period. The clearing of the various payments has resulted in a very good profile field 208 on January 26: (1) there is $9000 available in credit; (2) the sum of the balance and the available credit is equal to the credit limit, indicating that there are no outstanding payments being floated; (3) the status fields are clear to indicate that there is no internal delinquency or external prohibition on credit transactions; (4) the behavior score is high at 780; and (5) the window field has no suggestion of a large number of payments being made in a short period of time. Nevertheless, the method of the invention retains the historical facts in the form of the worst-profile record 225 that the account recently suffered from a higher balance, a level of available credit that indicates payments were being floated, a low behavior score, and a suspicious suggestion in the window field of many shortly spaced payments. To reflect the improved state of the worst-profile record 225, 60% of a tendered payment of $500 on January 26 is floated.

As time passes without any new suspicious activity, the pipeline 200 eventually drops the damaging historical information and the customer is automatically given greater flexibility with the account. For example, by January 31, shown in FIG. 2L, all of the profile records in the pipeline 200 contain positive information. The worst-profile record developed from these positive profile records is therefore itself also positive. Accordingly, with the positive worst-profile record 225 shown, a decision is made to float the entirety of the $500 payment made on January 31 and simply to credit the account in full with the payment.

The system continues to function in this manner. Should the customer begin to engage in activity that raises suspicion, the retention of historical information will automatically cause preventive measures such as those described above to be taken to control potential payment fraud.

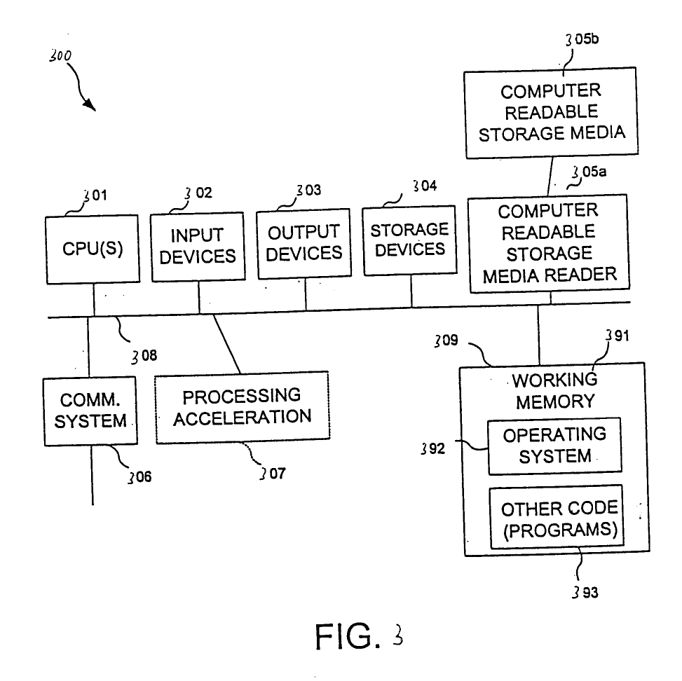

An example of the structure of a computer system 300 that may be used to implement the methods described above is shown in FIG. 3. This figure broadly illustrates how individual system elements may be implemented in a separated or more integrated manner. The computer system 300 is shown comprised of hardware elements that are electrically coupled via bus 308, including a processor 301, input devices 302, output devices 303, storage devices 304, a computer-readable storage media reader 305a, a communications system 306, a processing acceleration unit 307 such as a DSP or special-purpose processor, and a memory 309. The computer-readable storage media reader 305a is further connected to a computer-readable storage medium 305b, the combination comprehensively representing remote, local, fixed, and/or removable storage devices plus storage media for temporarily and/or more permanently containing computer-readable information. For the illustrated embodiment, the communications system 306 provides a connection with networks that may be used to collect payment and/or credit transaction information, among others, and may comprise a wired, wireless, modem, and/or other type of interfacing connection.

The computer system 300 also comprises software elements, shown as being currently located within working memory 391, including an operating system 392 and other code 393, such as a program designed to implement the methods and systems of the invention. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method for processing a payment towards a credit account, the method comprising:
retrieving a history of profile records for the credit account over a period of time preceding receipt of the payment, each such profile record corresponding to a date within the period of time and including an account balance for the credit account on the date and a value of credited payments made towards the credit account on the date; and
determining whether to float the payment from an analysis of the history of profile records.

2. The method recited in claim 1 wherein each such profile record further includes an indication whether any prior payments are floating on the date.

3. The method recited in claim 1 wherein each such profile record further includes the number of credited payments made towards the credit account within a time window preceding the date.

4. The method recited in claim 1 wherein each such profile record further includes a cumulative value of credited payments made towards the credit account within a time window preceding the date.

5. The method recited in claim 3 wherein the time window is at least as great as an expected time for the payment to clear.

6. The method recited in claim 1 wherein the period of time has a length at least as great as an expected time for the payment to clear.

7. The method recited in claim 1 wherein each such profile record further includes a behavior score.

8. The method recited in claim 1 wherein determining whether to float the payment comprises developing a worst-case profile from the history of profile records.

9. The method recited in claim 1 wherein determining whether to float the payment comprises considering the number of credited payments floated over the period of time.

10. The method recited in claim 1 wherein determining whether to float the payment comprises considering the number of credited payments made over the period of time.

11. The method recited in claim 1 wherein determining whether to float the payment comprises:
determining a fraction of the payment to float; and
determining a time to hold a remainder of the payment.

12. The method recited in claim 1 further comprising determining whether the payment comprises a cash or cash-equivalent payment.

13. A method for managing a credit account, the method comprising:
maintaining a history of profile records for the credit account, each such profile record corresponding to a date and including an account balance for the credit account on the date and an indication whether any prior payments are floating on the date;
determining a new profile record in response to receipt of a payment towards the credit account or of a request for a charge against the credit account; and
adding the new profile record to the history of profile records.

14. The method recited in claim 13 wherein determining the new profile record comprises determining whether to float the payment.

15. The method recited in claim 14 wherein determining whether to float the payment comprises:
determining a fraction of the payment to float; and
determining a time to hold a remainder of the payment.

16. The method recited in claim 14 wherein determining whether to float the payment comprises analyzing a plurality of profile records retrieved from the history.

17. The method recited in claim 13 wherein each such profile record further includes a behavior score.

18. A computer-readable storage medium having a computer-readable program embodied therein for directing operation of a computer system including a processor and a storage device, wherein the computer-readable program includes instructions for operating the computer system to process a payment towards a credit account in accordance with the following:
retrieving a history of profile records from the storage device for the credit account over a period of time preceding receipt of the payment, each such profile record corresponding to a date within the period of time and including an account balance for the credit account on the date and a value of credited payments made towards the credit account on the date; and
determining with the processor whether to float the payment from an analysis of the history of profile records.

19. The computer-readable storage medium recited in claim 18 wherein each such profile record further includes an indication whether any prior payments are floating on the date.

20. The computer-readable storage medium recited in claim 18 wherein each such profile record further includes the number of credited payments made towards the credit account within a time window preceding the date.

21. The computer-readable storage medium recited in claim 18 wherein each such profile record further includes a cumulative value of credited payments made towards the credit account within a time window preceding the date.

22. The computer-readable storage medium recited in claim 18 wherein each such profile record further includes a behavior score.

23. The computer-readable storage medium recited in claim 18 wherein determining with the processor whether to float the payment comprises developing a worst-case profile from the history of profile records.

24. A computer system comprising:
a storage device;
a processor in communication with the storage device; and
a memory coupled with the processor, the memory comprising a computer-readable storage medium having a computer-readable program embodied therein for operating the computer system to process a payment towards a credit account, the computer-readable program including:
instructions for retrieving a history of profile records from the storage device for the credit account over a period of time preceding receipt of the payment, each such profile record corresponding to a date within the period of time and including an account balance for the credit account on the date and a value of credited payments made towards the credit account on the date; and
instructions for determining with the processor whether to float the payment from an analysis of the history of profile records.

25. The computer system recited in claim 24 wherein the instructions for determining with the processor whether to float the payment comprise instructions for developing a worst-case profile from the history of profile records.

26. The computer system recited in claim 24 wherein each such profile record further includes an indication whether any prior payments are floating on the date.
